(19) United States
(12) Patent Application Publication
(10) Pub. No.: US 2013/0171359 A1
(43) Pub. Date: Jul. 4, 2013

(54) METHOD FOR MAKING CARBON NANOTUBE COMPOSITE

(71) Applicants: WEI XIONG, Beijing (CN); JIA-PING WANG, Beijing (CN); KAI-LI JIANG, Beijing (CN); SHOU-SHAN FAN, Beijing (CN)

(72) Inventors: WEI XIONG, Beijing (CN); JIA-PING WANG, Beijing (CN); KAI-LI JIANG, Beijing (CN); SHOU-SHAN FAN, Beijing (CN)

(73) Assignees: HON HAI PRECISION INDUSTRY CO., LTD., Tu-Cheng (TW); TSINGHUA UNIVERSITY, Beijing (CN)

(21) Appl. No.: 13/568,487

(22) Filed: Aug. 7, 2012

(30) Foreign Application Priority Data
Dec. 28, 2011 (CN) 201110447142.9

(51) Int. Cl. B05D 7/24; B82Y 30/00

(52) U.S. Cl. 427/385.5; 977/742

(57) ABSTRACT

A method for making a carbon nanotube composite film is provided. A PVDF solution is formed by dissolving a PVDF into a first solvent. A number of carbon nanotubes are provided and distributed into the PVDF solution to form a first suspension. The first suspension is transferred into a second solvent to form a second suspension. The second suspension is filtrated to obtain an intermediate, then the intermediate is dried. A solubility of first solvent in the second solvent is greater than a solubility of PVDF in the second solvent.

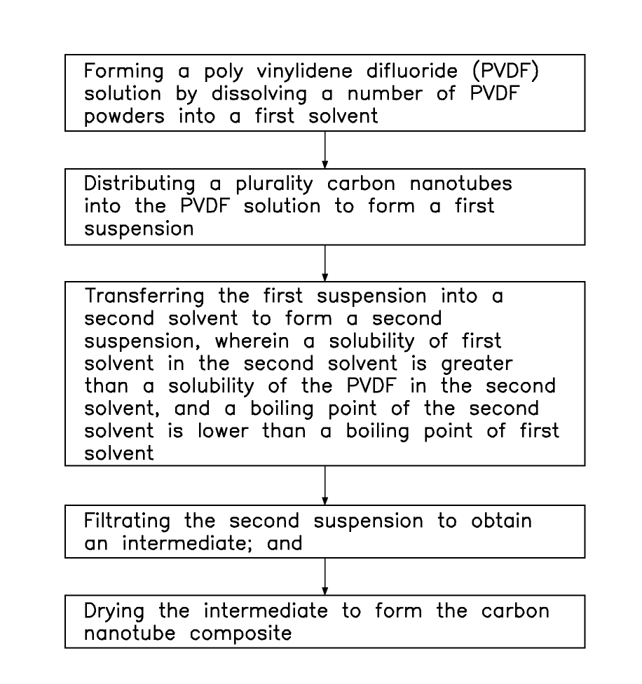

### CROSS-REFERENCE TO RELATED APPLICATIONS

This application claims all benefits accruing under 35 U.S.C. §119 from China Patent Application No. 201110447142.9, filed on Dec. 28, 2011 in the China Intellectual Property Office, the disclosure of which is incorporated herein by reference. This application is related to applications entitled, “METHOD FOR MAKING CARBON NANOTUBE COMPOSITES FILMS”, filed **** (Atty. Docket No. US44248), “CARBON NANOTUBE MICRO-WAVE ABSORBING FILMS”, filed **** (Atty. Docket No. US44262), “METHOD FOR MAKING CARBON NANOTUBE COMPOSITE FILMS”, filed **** (Atty. Docket No. US44263), and “CARBON NANOTUBE COMPOSITE FILMS”, filed **** (Atty. Docket No. US44264).

### BACKGROUND

1. Technical Field

The present disclosure relates to a method for making carbon nanotube composites.

2. Description of Related Art

Carbon nanotubes are tubules of carbon generally having diameters ranging from about 0.5 nanometers to about 50 nanometers. Because carbon nanotubes are microscopic structures, it is necessary to assemble the carbon nanotubes into macroscopic structures. A carbon nanotube/poly vinylidene difluoride (CNT/PVDF) composite is one kind of macroscopic structure of carbon nanotubes.

A method for making the CNT/PVDF composite comprises steps of: providing a plurality of carbon nanotubes powders and a poly vinylidene difluoride/dimethylformamide (PVDF/DMF) solution; dispersing the plurality of carbon nanotubes powders in the PVDF/DMF solution to form a mixture; and heating the mixture to form the CNT/PVDF composite under a temperature ranging from about 80 degrees to 100 degrees. The CNT/PVDF composite has a positive temperature coefficient of resistance. This means that within a specific temperature range, its resistance rises sharply as the temperature rises. Taking advantage of these features, the CNT/PVDF composite may be used for example as temperature sensors, current limiting elements, over-current protection elements and the like. However, because the boiling point of the DMF is relatively high, about 152° C., the DMF can hardly volatilize from the plurality of carbon nanotubes powders during the heating process. Thus, the time needed for making the CNT/PVDF composite is very long, and the process is complex, which limits applications of such CNT/PVDF composite.

What is needed, therefore, is to provide a method for making a carbon nanotube composite, which can overcome the above-described shortcomings.

### BRIEF DESCRIPTION OF THE DRAWINGS

Many aspects of the embodiments can be better understood with reference to the following drawings. The components in the drawings are not necessarily to scale, the emphasis instead being placed upon clearly illustrating the principles of the present disclosure. Moreover, in the drawings, like reference numerals designate corresponding parts throughout the several views.

The FIGURE shows a flowchart of one embodiment of a method of making a carbon nanotube composite.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

Referring to FIGURE, a method for making a carbon nanotube composite according to one embodiment can include the following steps:

(S11) forming a poly vinylidene difluoride (PVDF) solution by dissolving a number of PVDF powders into a first solvent;

(S12) distributing a plurality of carbon nanotubes into the PVDF solution to form a first suspension;

(S13) transferring the first suspension into a second solvent to form a second suspension, wherein a solubility of first solvent in the second solvent is greater than a solubility of the PVDF in the second solvent, and a boiling point of the second solvent is lower than a boiling point of first solvent;

(S14) filtrating the second suspension to obtain an intermediate; and

(S15) drying the intermediate to form the carbon nanotube composite.

In step (S11), the first solvent is not limited, as long as the PVDF powders can be completely dissolved in the first solvent. The first solvent can be a polar solvent, such as n-methyl pyrrolidone (NMP), dimethyl sulfoxide (DMSO), dimethylformamide, dimethyl acetamide, or combinations thereof. In one embodiment, the first solvent is NMP. A weight percentage of the PVDF in the PVDF solution can be lower than 10 wt %. In some embodiments, the weight percentage of the PVDF in the PVDF solution ranges from about 3 wt % to about 8 wt %. In one embodiment, the weight percentage of the PVDF in PVDF solution is about 5 wt %.

In step (S12), a length of the carbon nanotubes can range from about 50 nanometers to about 50 millimeters, a diameter of the carbon nanotubes can range from about 0.5 nanometers to about 50 nanometers. The carbon nanotubes are uniformly distributed in the PVDF solution as desired by means such as application of ultrasonic vibrations or mechanical agitation, and two or more of these carbon nanotubes are electrically connected to each other. A weight ratio between the carbon nanotube and the PVDF in the first suspension can range from about 1:3 to about 1:1000. In some embodiments, the weight ratio between the carbon nanotube and the PVDF in the first suspension ranges from about 1:3 to about 1:10. In one embodiment, the weight ratio between the carbon nanotube and the PVDF in the first suspension is about 1:5.

In step (S13), a solubility of the PVDF in the second solvent can be lower than a solubility of the first solvent in the second solvent. The solubility of the PVDF in the second solvent can be lower than 1 gram. In some embodiments, the solubility of the PVDF in the second solvent is lower than 0.1 gram. The solubility of the first solvent in the second solvent can be higher than 10 grams. The boiling point of the second solvent can be lower than the boiling point of the first solvent. In some embodiments, the boiling point of the second solvent is lower than 100 degrees. The second solvent can be water, alcohol, acetone, chloroform or combinations thereof. In one embodiment, the second solvent is water. A weight ratio between the second solvent and the first solvent in the second suspension can be greater than 1:1. In some embodiments, the weight ratio between the second solvent and the first solvent in the second suspension ranges from about 5:1 to about 10:1.

Because the solubility of the first solvent in the second solvent is greater than the solubility of the PVDF in the second solvent, the first solvent can be diffused in the second solvent when the first suspension is transferred into the second solvent. Thus, the carbon nanotubes and the PVDF can be precipitated from the first suspension to form the second suspension. The carbon nanotubes and the PVDF can be uniformly dispersed in the second suspension. Meanwhile, the PVDF can be covered on surfaces of the carbon nanotubes, to prevent the carbon nanotubes from aggregating together.

In step (S14), the second suspension can be filtrated by a vacuum filtration device, and the carbon nanotubes can be uniformly distributed in the PVDF to form the intermediate. It is to be noted that, a little amount of the first solvent and the second solvent can be retained in the intermediate.

In step (S15), the intermediate can be dried by an oven for a period of time at a predetermined temperature to form the carbon nanotube composite. The predetermined temperature can be lower than the boiling point of the second solvent. It should be noted that, during the drying process, the PVDF can be solidified and deposited on the surfaces of the carbon nanotubes. Meanwhile, the first solvent and the second solvent can be evaporated from the intermediate quickly. Because there is little amount of the first solvent and the second solvent left in the intermediate. In one embodiment, the intermediate is dried at about 100° C. for about 0.5 hours. Furthermore, the intermediate can be dried by an active process or an inactive process (e.g. air drying).

The drying process can be carried out in a vacuum condition. The boiling point of the second solvent can be lower in a vacuum condition, thus, the second solvent can be evaporated from the intermediate even more quickly and the intermediate can be dried at a lower temperature.

After the second solvent is evaporated from the intermediate to form the carbon nanotube composite, a step of pressing the carbon nanotube composite can be further executed. Thus, a density of the carbon nanotube composite can be improved.

It should be noted that, if a polymer can only be dissolved in a first solvent having a relatively high boiling point (e.g. greater than 100° C.), a second solvent having a relative low boiling point (e.g. lower than 100° C.) and capable of dissolving the first solvent can be chosen to precipitate the polymer from the first solvent. Thus, the efficiency for making the carbon nanotube composite can be improved. For example, the first solvent for making a polyethylene terephthalate/carbon nanotube composite can be methyl phenol (201.9° C.), nitrobenzene (210.9° C.), and parachlorophenol (217° C.), and the second solvent can be alcohol; and the first solvent for making a polyamide (PA)/carbon nanotube composite can be methanoic acid (100.8° C.), methyl phenol (201.9° C.), and NMP, and the second solvent can be methanol or alcohol.

The embodiments for making a carbon nanotube composite have at least the following advantages. First, during the filtrating process, most of the first solvent and the second solvent are filtrated from the intermediate, thus, the time that is needed for making the carbon nanotube composite is relatively short. Second, by precipitating the PVDF from the first suspension, the PVDF can be uniformly precipitated in the surfaces of the carbon nanotubes to prevent the carbon nanotubes from aggregating together. Thus, the carbon nanotube composite has the uniformity. Furthermore, the method of making the carbon nanotube composite is a simple process with a relatively low cost.

The above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method for making a carbon nanotube composite, the method comprising the following steps:
(a) dissolving a poly vinylidene difluoride (PVDF) into a first solvent to form a PVDF solution;
(b) making a first suspension by distributing a plurality of carbon nanotubes into the PVDF solution;
(c) forming a second suspension by transferring the first suspension into a second solvent, wherein a solubility of first solvent in the second solvent is greater than a solubility of the PVDF in the second solvent, and a boiling point of the second solvent is lower than a boiling point of the first solvent;
(d) filtrating the second suspension to obtain an intermediate; and
(e) drying the intermediate.

2. The method of claim 1, wherein the solubility of first solvent in the second solvent is ten times larger than the solubility of PVDF in the second solvent.

3. The method of claim 1, wherein the solubility of first solvent in the second solvent is lower than 1 gram.

4. The method of claim 1, wherein the solubility of first solvent in the second solvent is greater than 10 grams.

5. The method of claim 1, wherein the first solvent is selected from the group consisting of n-methyl pyrrolidone, dimethyl sulfoxide, dimethylformamide, dimethyl acetamide, and combinations thereof.

6. The method of claim 1, wherein the boiling point of the second solvent is lower than 100 degrees.

7. The method of claim 1, wherein the second solvent is selected from the group consisting of water, alcohol, acetone, chloroform and combinations thereof.

8. The method of claim 1, wherein a weight percentage of the PVDF in the PVDF solution is lower than or equal to 10%.

9. The method of claim 1, wherein a weight ratio between the carbon nanotubes and the PVDF in the first suspension is in a range from about 1:3 to about 1:1000.

10. The method of claim 1, wherein a weight ratio between the carbon nanotubes and the PVDF in the first suspension is in a range from about 1:3 to about 1:10.

11. The method of claim 1, wherein a weight ratio between the second solvent and the first solvent in the second suspension is greater than or equal to 1:1.

12. The method of claim 1, wherein a weight ratio between the second solvent and the first solvent in the second suspension is in a rage from about 5:1 to about 10:1.

13. The method of claim 1, wherein the step of drying the intermediate is carried out under a vacuum condition.

14. A method for making a carbon nanotube composite, the method comprising the following steps:
(a) dissolving a polymer into a first solvent to form a polymer solution;
(b) forming a first suspension by distributing a plurality of carbon nanotubes into the polymer solution;
(c) forming a second suspension by transferring the first suspension into a second solvent, wherein a solubility of the first solvent in the second solvent is greater than a solubility of the polymer in the second solvent, and a boiling point of the second solvent is lower than a boiling point of first solvent;
(d) filtrating the second suspension to obtain an intermediate; and
(e) drying the intermediate.

15. The method of claim 14, wherein the polymer is polyethylene terephthalate, the first solvent is selected from the group consisting of methyl phenol, nitrobenzene, parachlorophenol and combinations thereof, and the second solvent is alcohol.

16. The method of claim 14, wherein the polymer is polyamide, the first solvent is selected from the group consisting of methanoic acid, methyl phenol, NMP and combinations thereof, and the second solvent is selected from the group consisting of methanol, alcohol and combinations thereof.

17. The method of claim 14, wherein the solubility of the first solvent in the second solvent is ten times larger than the solubility of the polymer in the second solvent.

18. The method of claim 14, wherein a weight percentage of the polymer in the polymer solution is lower than or equal to 10%.

19. The method of claim 14, wherein a weight ratio between the carbon nanotubes and the polymer in the first suspension is in a range from about 1:3 to about 1:1000.

20. The method of claim 14, wherein a weight ratio between the second solvent and the first solvent in the second suspension is greater than or equal to 1:1.
